(19) United States
(12) Patent Application Publication
(10) Pub. No.: US 2024/0288847 A1
(43) Pub. Date: Aug. 29, 2024

(54) Control System and Control Method

(71) Applicant: Hitachi, Ltd., Chiyoda-ku, Tokyo (JP)

(72) Inventors: Shinji ISHIHARA, Tokyo (JP); Wataru TANAKA, Tokyo (JP); Kazuya SUGIMOTO, Tokyo (JP)

(21) Appl. No.: 18/570,707

(22) PCT Filed: Apr. 11, 2022
(86) PCT No.: PCT/JP2022/017486

§ 371 Date: Dec. 15, 2023

(30) Foreign Application Priority Data
Jul. 9, 2021 (JP) 2021-114452

(51) Int. Cl. G05B 19/408; G05B 19/404

(52) U.S. Cl. CPC G05B 19/408; G05B 19/404

(57) ABSTRACT

A control system comprises: a control quantity calculating unit for calculating, on the basis of an operation target of a controlled object, an operation evaluation index, and an operation model, a control quantity for driving the controlled object, which is a working machine; and a model updating unit for updating the operation model on the basis of a state quantity of the controlled object. The control system may additionally be provided with: a command converting unit for converting the control quantity into a command value for a drive unit of the controlled object; and a conversion updating unit for updating a conversion characteristic from the control quantity to the command value, on the basis of the command value and a response of the controlled object.

### TECHNICAL FIELD

The present invention relates to a control system and a control method capable of flexibly responding to a change in a controlled object that is a working machine and a change in a value to be maximized.

### BACKGROUND ART

In a large-scale system such as a chemical plant or a power plant, even when an operation method is slightly changed, efficiency (for example, productivity or a power generation amount), an operation cost (for example, a fuel cost), and an environmental load (for example, an emission amount of carbon dioxide or the like) are greatly changed. Therefore, it is important to appropriately operate and control the system so as to simultaneously optimize a plurality of evaluation indexes (efficiency, operation cost, and environmental load). However, in the large-scale system as described above, it is difficult to grasp a correspondence between change of a control parameter and variation of various evaluation indexes due to complexity of configuration of the system, and thus, it is difficult to adjust the control parameter.

In response to such a problem, PTL 1 presents a plant control device that autonomously learns a plant operation method (control parameter) so as to optimize a specific evaluation value (described as a cost evaluation value in PTL 1) for the plant. Specifically, the cost evaluation value is plant fuel consumption, production efficiency, the operation cost which is a cost required for emission treatment, and an equipment cost required for parts replacement of the plant. A mechanism capable of evaluating the cost evaluation value on a computer is constructed using an operation characteristic model that simulates an operation characteristic of the plant and a device characteristic model that calculates a deterioration degree and a replacement time of a device from a device state, and a parameter of a control logic or a control circuit (for example, proportional integral control (PI control)) is adjusted (autonomously learned) so as to improve the cost evaluation value.

### CITATION LIST

### Patent Literature

PTL 1: JP 2012-053505 A

### SUMMARY OF INVENTION

### Technical Problem

In addition to the plant, a work site with multiple work vehicles and workers, such as a factory, a distribution site, and a construction site, can also be considered a large-scale system. When an action plan for the work vehicle and the worker in the work site is considered as an operation amount (a control command), and the productivity, a conveyance capacity, and construction performance in the work site are used as evaluation values, there is a possibility that an optimal action plan of the work site can be designed by applying a method described in PTL 1.

However, in PTL 1, the control logic (PI control of PTL 1) itself does not have a mechanism for optimizing the evaluation value (cost evaluation value). That is, it is not possible to obtain an operation control method for immediately optimizing the evaluation value when there is a change in constituent elements of the evaluation value, and it is necessary to pass through a learning period.

In the case of a stably operating system such as a plant, since steady work (for example, synthesizing a specific chemical substance or generating electricity) is mainly performed, the constituent elements of the evaluation value are not frequently changed. On the other hand, in the work site of distribution or construction as described above, there are many unsteady works in which daily work contents change, and the elements constituting the evaluation value also frequently change. For example, when an unskilled person is assigned to the factory, a change in the evaluation value such as ensuring safety occurs even if the productivity is lowered. In the method of PTL 1, it is not easy to flexibly cope with such a situation.

Furthermore, in the above-described work site, not only the evaluation value but also the working machine (forklift, hydraulic excavator, or the like) introduced into the work site as the constituent element is frequently updated. For example, the forklift on which the worker conventionally rides is replaced with the forklift that operates by autonomous driving due to shortage of the workers. In such a case, it is necessary to construct not only work instructions for an autonomous machine but also finer control such as how to move the autonomous machine according to the work instructions. Furthermore, in addition to replacing a conventional machine with the autonomous machine, an existing machine may be retrofitted with a sensor or a control device and operated as the autonomous machine. As described above, there are various methods for constructing the control system.

In PTL 1, replacement of the constituent element with the same component (replacement due to component lifetime) is considered. However, a change to another constituent element (replacement or improvement of the working machine) intended to improve the productivity as described above is not considered. In addition, it is not possible to cope with a layer of specific control of the constituent element.

The present invention has been made in view of such a background, and an object of the present invention is to provide a control system and a control method capable of flexibly responding to an evaluation value desired to be achieved and differences in controlled objects.

### Solution to Problem

In order to solve the above problem, a control system according to the present invention includes: a control quantity calculating unit for calculating, on the basis of an operation target, an evaluation index of an operation, and an operation model of a controlled object that is a working machine, a control quantity for driving the controlled object; and a model updating unit for updating the operation model on the basis of a state quantity of the controlled object.

### Advantageous Effects of Invention

According to the present invention, it is possible to provide the control system and the control method capable of flexibly responding to the evaluation value desired to be achieved and the differences in the controlled objects.

Problems, configurations, and effects other than those described above will be clarified by the following description of embodiments.

### BRIEF DESCRIPTION OF DRAWINGS

FIG. 1 is a functional block diagram of a control system according to the present embodiment.

FIG. 2 is a functional block diagram of a command converting unit according to the present embodiment.

FIG. 3 is a graph for explaining a dynamic characteristic of a drive unit according to the present embodiment.

FIG. 4 is a flowchart of control processing according to the present embodiment.

FIG. 5 is a diagram illustrating a warehouse provided in a factory or a distribution site according to a first embodiment.

FIG. 6 is a functional block diagram of a forklift according to the first embodiment.

FIG. 7 is a diagram for explaining a dynamic characteristic of the forklift according to the first embodiment.

FIG. 8 is an overhead view of a construction site according to a second embodiment.

FIG. 9 is a configuration diagram of a hydraulic excavator according to the second embodiment.

FIG. 10 is a configuration diagram of a dump truck which is an example of a conveyance vehicle according to the second embodiment.

FIG. 11 is a functional block diagram of the hydraulic excavator and the dump truck according to the second embodiment.

FIG. 12 is a diagram for explaining a basic model of the hydraulic excavator according to the second embodiment.

FIG. 13 is a diagram for explaining conversion of a control quantity into a command value according to the second embodiment.

FIG. 14 is a diagram for explaining an engine model according to the second embodiment.

### DESCRIPTION OF EMBODIMENTS

Hereinafter, a control system in a mode (an embodiment) for carrying out the present invention will be described. An object (A controlled object) whose operation is controlled by the control system is a working machine such as a forklift or a hydraulic excavator. The control system sets a tracking target (operation target, route, track) of the controlled object, and calculates a control quantity for the controlled object such that the controlled object operates along the tracking target. When calculating the control quantity, the control system calculates the control quantity so that an evaluation value (evaluation function, evaluation index) of the operation is maximized or minimized on the basis of a basic model (an operation model) that is a physical model indicating the operation of the controlled object. Examples of the evaluation value include productivity, energy consumption, and safety (distance to a worker).

The basic model shown as a state equation (motion equation) includes physical parameters. The control system updates some physical parameters (for example, a friction coefficient) while observing the operation (a state quantity) of the controlled object for the control quantity.

The control quantity is converted into a command value and output to a drive unit of the controlled object. The control system updates a parameter of a function (for example, a coefficient of a transfer function) to be converted into the command value while observing a response of the controlled object to the control quantity.

By updating the basic model and a conversion function according to the operation and the response of the controlled object in this manner, the control system can flexibly cope with a change of the controlled object and a change of the evaluation function. For example, even when the controlled object (working machine) is replaced or the evaluation value (evaluation function) is updated, the control system can cope with such a situation without human intervention, and control the controlled object so that the evaluation value is maximized or minimized.

### <<Overall Configuration of Control System>>

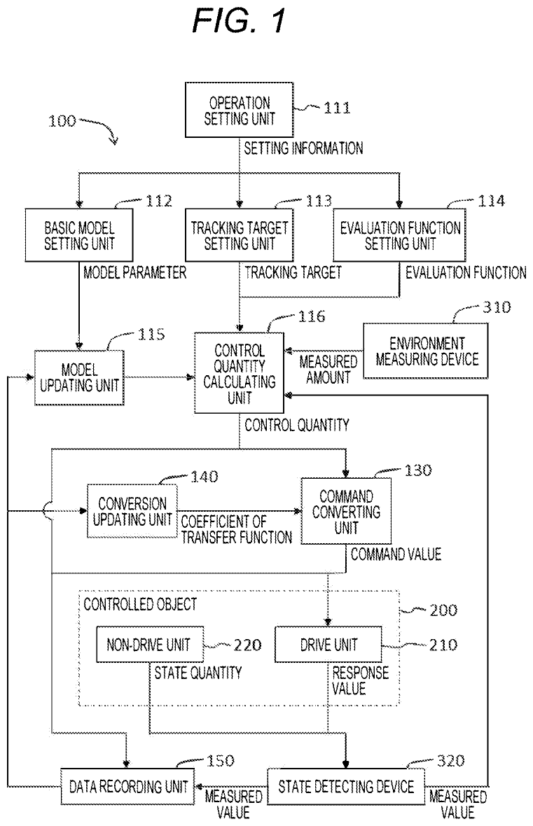

FIG. 1 is a functional block diagram of a control system 100 according to the present embodiment. The control system 100 is configured to include an operation setting unit 111, a basic model setting unit 112, a tracking target setting unit 113, an evaluation function setting unit 114, a model updating unit 115, a control quantity calculating unit 116, a command converting unit 130, and a conversion updating unit 140. These functional units function on one or more computers or microprocessors. An environment measuring device 310, a state detecting device 320, and a data recording unit 150 will be described later.

Hereinafter, a controlled object 200, the operation setting unit 111, the basic model setting unit 112, the tracking target setting unit 113, the evaluation function setting unit 114, the model updating unit 115, the control quantity calculating unit 116, the command converting unit 130, and the conversion updating unit 140 will be described.

### <<Controlled Object>>

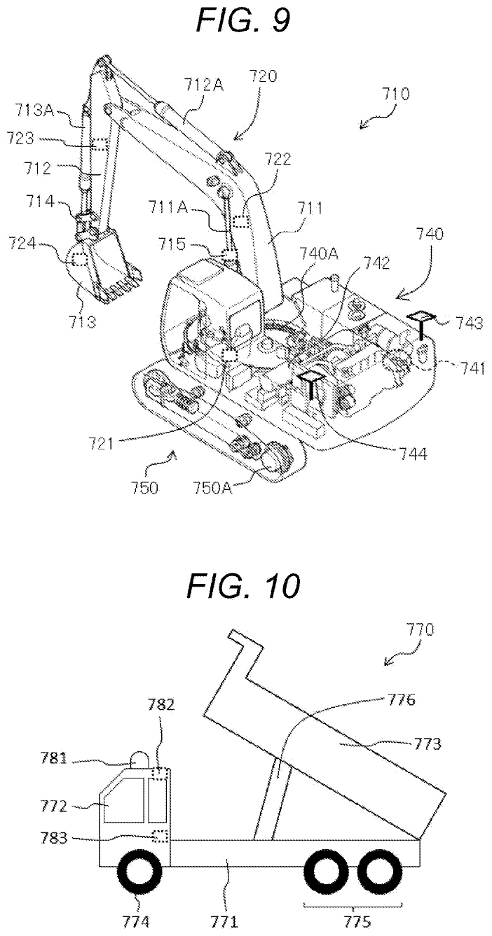

The controlled object 200 is the working machine (for example, see a hydraulic excavator 710 in FIG. 9 to be described later), and is configured to include a drive unit 210 and a non-drive unit 220. The drive unit 210 is an actuator such as a motor. The non-drive unit 220 is a constituent element of the controlled object 200 other than the actuator. The drive unit 210 operates in accordance with the command value received from the control system 100 (the command converting unit 130 in FIG. 1). The command value is, for example, a moving speed or a steering angular velocity.

The state detecting device 320 collects various types of information as measured values from sensors attached to the drive unit 210 and the non-drive unit 220. The state detecting device 320 may detect and collect a state of the controlled object 200 from a sensor installed outside the controlled object 200 (operating environment, work site). The measured values include a position and azimuth angle (orientation) of the controlled object 200, a response of the drive unit 210 to the command value input from the command converting unit 130, and the state quantity (for example, remaining fuel amount) of the non-drive unit 220.

The measured values of the sensor collected by the state detecting device 320, the output (control quantity) of the control quantity calculating unit 116, and an output (the command value) of the command converting unit 130 are recorded in the data recording unit 150. In addition, the measured values corresponding to a state quantity x (for example, position, azimuth angle, speed, and angular velocity, see Expression (1) described later) of the controlled object 200 collected by the state detecting device 320 are transmitted to the control quantity calculating unit 116 and used for calculation of the control quantity.

### <<Operation Setting Unit>>

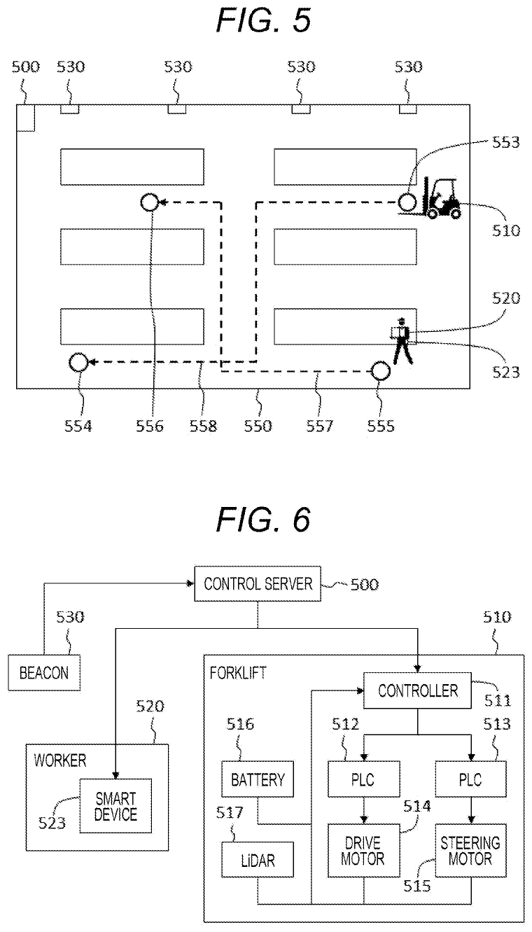

The operation setting unit 111 is a user interface in which an operator who operates the control system 100 performs various settings. The operator of the control system 100 or the controlled object 200 sets the basic model of the controlled object 200, work to be achieved by the controlled object 200, and the evaluation function to be described later via the operation setting unit 111. The setting of the work is, for example, setting a start point and a goal point of the forklift (see FIG. 5 to be described later).

### <<Basic Model Setting Unit>>

When the operation setting unit 111 receives setting of the controlled object 200 from the operator, the basic model setting unit 112 sets the basic model (operation model) related to the controlled object 200. The basic model is a physical model related to the operation (motion) of the controlled object 200, and is expressed by a general motion equation (state equation) such as a two-wheeled vehicle model or a four-wheeled vehicle model in the case of a vehicle, and a link system in the case of a work arm or the hydraulic excavator. The motion equation reflects physical parameters (also simply referred to as parameters) described in a catalog (product specification) of the controlled object.

Among the parameters of the basic model, a numerical value such as a friction coefficient or a viscosity term for which it is difficult to obtain an accurate value in advance is desirably set to 0 as an initial value. The model updating unit 115 described later updates such a physical parameter for which it is difficult to obtain the accurate value in advance by observing an actual operation of the controlled object. The basic model is expressed by the state equation (motion equation) as shown in Expression (1).

### Expression 1

\dot{x}=f(x,u,p,q) (1)

In Expression (1), x is a state quantity of the controlled object 200, u is a control input (control quantity), p is a known parameter, and q is an unknown parameter. A dot “·” on the left side indicates time differentiation. For example, when the state quantity x is a position, the time differentiation of the state quantity on the left side is a speed of the controlled object 200 in the state quantity x and the control quantity u. When the vehicle is taken as an example, the state quantity x is a vector including the position and the azimuth angle, the control quantity u corresponds to steering or speed, the known parameter p corresponds to vehicle inertia, and the unknown parameter q corresponds to a friction coefficient. The unknown parameter q is the numerical value for which it is difficult to obtain the accurate value in advance as described above.

### <<Tracking Target Setting Unit>>

When the operation setting unit 111 receives the setting of the work (task) from the operator, the tracking target setting unit 113 sets the tracking target which is a target value that the controlled object 200 should follow (operate, work). The target value is, for example, a trajectory of the vehicle or a trajectory of the work arm. The tracking target setting unit 113 calculates a shortest route on the basis of the start point and the goal point of the controlled object 200, and sets the shortest route as the tracking target. An existing shortest route calculation method (route planning method) is used to calculate the shortest route.

Note that the route is not limited to the trajectory from the start point to the goal point of the vehicle, but includes a trajectory of a change in the trajectory of the work arm, a position and posture of a work robot, and the like, and is a route (operation path, motion trajectory) from a start state to an end state.

### <<Evaluation Function Setting Unit>>

The operator inputs an operation policy of the control system 100 including the controlled object 200 using the operation setting unit 111. The operation policy includes one or more key performance indicators (KPIs). Constituent elements of the KPI may include not only evaluation values related to the productivity, the safety, and environmental load which are viewpoints of a manager but also comfort (for example, fatigue and stress) which is the viewpoint of the worker.

When the operation setting unit 111 receives the setting of the operation policy from the operator, the evaluation function setting unit 114 converts the operation policy into a mathematical expression. The mathematical expression can be expressed by a linear combination of N weights at and an evaluation function element jᵢ(X), for example, as in Expression (2).

$$[ Expression 2 ]$$

$$J = {\sum }_{i = 1}^{N} {α}_{i} \cdot {j}_{i} ( X ) \qquad ( 2 )$$

X is a state quantity of an environment including various kinds of information collected from the sensor by the environment measuring device 310 to be described later. Note that the state quantity X desirably includes the state quantity of the controlled object. The evaluation function element j₁(X) relates to the KPI. Note that a specific design method of an evaluation function J (evaluation index) will be described together with Examples 1 and 2 to which the control system to be described later is applied.

The weight αᵢ is a coefficient for determining a priority of the evaluation function element jᵢ(X) which is a corresponding KPI. For example, it is assumed that the evaluation function element j₁(X) is a KPI related to the productivity, the evaluation function element j₂ (X) is a KPI related to the safety, and the operation policy is configured by the two evaluation function elements. In such a case, when an unskilled person is at the work site, α₁ is decreased and α₂ is increased, so that the operation with priority on the safety can be realized. In addition, when there is no possibility that an accident occurs, for example, when there is only one working machine, it is also possible to operate to maximize only the productivity by setting the weight α₂ related to the safety to 0.

The environment measuring device 310 acquires the measured values from a sensor group capable of collecting sufficient information for evaluating the KPI. Examples of the sensor include a camera for grasping a conveyance status of an article in a case of evaluating the productivity at a distribution site and a sensor for reading tag information. In the case of evaluating the safety, a distance sensor or a light detection and ranging (LiDAR), which is mounted on the forklift and measures the distance to the worker or an obstacle (a contact accident occurs when the distance is 0), is assumed. Further, in the case of evaluating the environmental load, a sensor for measuring energy (fuel consumption and power consumption) consumed by the working machine including the controlled object 200 is assumed. In the case of evaluating the degree of fatigue and the stress of the worker, a device such as a smart watch that measures a heart rate having a correlation with fatigue and stress is assumed. The KPI may include environmental information (environmental state) of the work site such as an amount of noise and dust accompanying the operation of the controlled object 200.

### <<Control Quantity Calculating Unit>>

The control quantity calculating unit 116 calculates the control quantity on the basis of the basic model (see Expression (1)) such that the controlled object 200 operates along the tracking target and maximizes or minimizes the evaluation function J (see Expression (2)). Specifically, the control quantity calculating unit 116 calculates the control quantity u that maximizes or minimizes the sum of evaluation functions from the time k=t to the time k=t+t_{N} for the evaluation function J as expressed in Expression (3) described later. As a method for calculating such a control quantity u, there is a numerical solution of an optimization problem or a model predictive control problem.

$$[ Expression 3 ]$$

$${J}_{MPC} = {\sum }_{k = t}^{t + {t}_{N}} J [ k ] \qquad ( 3 )$$

### <<Model Updating Unit>>

Since the unknown parameter q is included in the basic model (state equation, see Expression (1)), there is a difference between the operation of the controlled object 200 indicated by the basic model (calculated from the basic model) referred to by the control quantity calculating unit 116 and the actual operation of the controlled object 200. Therefore, there is a possibility that an optimum control quantity u cannot be calculated when the unknown parameter q remains at the initial value 0.

The model updating unit 115 estimates the unknown parameter q using the state quantity x of the controlled object 200 recorded in the data recording unit 150 and updates the basic model (state equation). In addition to the position and the azimuth angle of the controlled object 200, the state quantity x may include the response of the drive unit 210 to the command value input from the command converting unit 130 and the state quantity of the non-drive unit 220. The model updating unit 115 may estimate the unknown parameter q by constructing a nonlinear Kalman filter for an extended system including the unknown parameter q and performing sequential state estimation. In addition, the model updating unit 115 may estimate the unknown parameter q by the least squares method by performing batch processing on time-series data of a specific period.

It is desirable that the model updating unit 115 updates the basic model (state equation) after confirming that the estimated unknown parameter q is a valid value. For example, it is desirable to check whether the unknown parameter q does not physically contradict and falls within an assumed value. For example, when the unknown parameter q, which has to be a positive value such as a friction coefficient, is negative, the model updating unit 115 does not reflect the unknown parameter q in the basic mode. Further, even if a true value is unknown, for the unknown parameter q whose nominal value and range of variation are known, when a value deviating from the nominal value and the range of variation is calculated, the calculated value is not reflected in the basic model.

Note that when the unknown parameter q is calculated as the value deviating from the nominal value and the range of variation, there is a possibility that a failure has occurred in some devices of the controlled object 200. The model updating unit 115 may prompt the operator of the controlled object 200 to perform maintenance, or may notify the control quantity calculating unit 116 to stop the controlled object 200.

### <<Command Converting Unit and Conversion Updating Unit>>

The control quantity calculating unit 116 calculates the optimum control quantity u related to the state equation (see Expression (1)), but an actual controlled object 200 may not be able to use the control quantity (physical quantity) as it is. For example, in the case of a vehicle-based machine, the control quantity u is a speed command, but the drive unit 210 that drives the controlled object 200 may be controlled as an accelerator operation (or a brake operation). In such a case, it is necessary to determine a correspondence between the speed command and the accelerator operation or the brake operation by some methods. This is also a conversion operation required when automating the vehicle-based machine designed on the premise that a driver operates. The command converting unit 130 converts the control quantity calculated by the control quantity calculating unit 116 into the command value to be an input (command) to the drive unit 210.

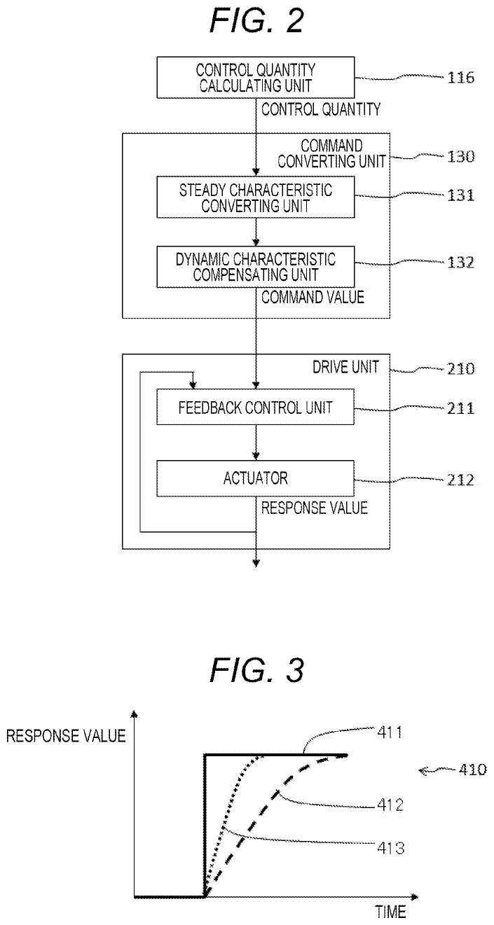

FIG. 2 is a functional block diagram of the command converting unit 130 according to the present embodiment. The command converting unit 130 is configured to include a steady characteristic converting unit 131 and a dynamic characteristic compensating unit 132. The steady characteristic converting unit 131 performs steady physical quantity conversion. For example, if the control quantity u calculated by the control quantity calculating unit 116 and a command value v to the drive unit 210 have a proportional conversion characteristic, the conversion (conversion function) is indicated by a constant multiple. Further, if the control quantity u and the command value v have a specific conversion characteristic, the conversion can be performed using, for example, a conversion table.

When such a conversion characteristic is described in a catalog or specification of an actuator 212 of the drive unit 210, it is desirable to use the information. When the information on the conversion characteristic cannot be used, the conversion table can be constructed by applying the control quantity u and verifying a response value w of the drive unit 210. In this case, the conversion table is designed with the response value w instead of the command value v, however, since a feedback control unit 211 is generally incorporated in the drive unit 210, the response value w and the command value v match each other, and thus there is no problem in practical use.

Although the steady characteristic converting unit 131 outputs a steady value of the command value v, the drive unit 210 does not immediately reach that value, but has some kind of dynamic characteristic. FIG. 3 is a graph 410 for explaining the dynamic characteristic of the drive unit 210 according to the present embodiment. For example, it is assumed that the drive unit 210 has a response characteristic expressed by the transfer function of Expression (4).

$$[ Expression 4 ]$$

$$\frac{{b}_{0} {s}^{2} + {b}_{1} s + {b}_{2}}{{a}_{0} {s}^{2} + {a}_{1} s + {a}_{2}} \qquad ( 4 )$$

Then, even when the command value v (see reference numeral 411) is provided stepwise, a response value w1 (see reference numeral 412) slowly rises. The output of the response value w (operation) of the drive unit 210 to the input of the command value v is delayed, and a temporal relationship between the input and the output is the dynamic characteristic. If the response is slower than expected, desired control performance cannot be achieved. The dynamic characteristic compensating unit 132 performs compensation in consideration of such a dynamic characteristic (delay in response to the command value v). Specifically, the conversion updating unit 140 expresses the dynamic characteristic compensating unit 132 by the transfer function of Expression (5), and calculates coefficients c₀ to c₂ and d₀ to d₂ so that the response value w of the drive unit 210 to the output of the steady characteristic converting unit 131 matches a transfer function T_{d}(s) (see Expression (6)) of an ideal response value w2 (see reference numeral 413).

$$[ Expression 5 ]$$

$$\frac{{d}_{0} {s}^{2} + {d}_{1} s + {d}_{2}}{{c}_{0} {s}^{2} + {c}_{1} s + {c}_{2}} \qquad ( 5 )$$

$$[ Expression 6 ]$$

$${T}_{d} ( s ) = \frac{{d}_{0} {s}^{2} + {d}_{1} s + {d}_{2}}{{c}_{0} {s}^{2} + {c}_{1} s + {c}_{2}} \times \frac{{b}_{0} {s}^{2} + {b}_{1} s + {b}_{2}}{{a}_{0} {s}^{2} + {a}_{1} s + {a}_{2}} \qquad ( 6 )$$

This can be realized by calculating the coefficients c₀ to c₂ and d₀ to d₂ so as to satisfy Expression (6) if the transfer function (see Expression (4)) of the drive unit 210 is obtained.

This is a design method of general pre-filter feedforward control. The transfer function of the drive unit 210 can be identified by performing system identification from input/output data obtained when the drive unit 210 is actually operated. The conversion updating unit 140 performs this identification to obtain the coefficients c₀ to c₂ and d₀ to d₂, and updates the dynamic characteristic compensating unit 132. In other words, the conversion updating unit 140 updates the dynamic characteristic compensating unit 132 on the basis of the command value that is the input of the drive unit 210 and the response (response value) that is the output of the drive unit 210, and updates the conversion characteristic of the command converting unit 130.

Note that the coefficients c₀ to c₂ and d₀ to d₂ that satisfy Expression (5) cannot be obtained depending on the degree of the transfer function of the drive unit 210, the degree of the dynamic conversion characteristic (see Expression (5)), and the degree of the transfer function T_{d}(s) of the ideal response. In such a case, a data drive control method of designing the coefficients c₀ to c₂ and d₀ to d₂ so as to obtain a response value as close as possible to the ideal response value w2 may be employed.

It is desirable that the conversion updating unit 140 updates the dynamic characteristic compensating unit 132 after confirming that the obtained coefficients c₀ to c₂ and d₀ to d₂ are valid values. For example, when signs of the coefficients c₀ to c₂ do not match, there is an unstable pole, and thus there is a possibility that the command value v diverges. Therefore, when such a coefficient is obtained, the conversion updating unit 140 does not reflect the coefficient in the dynamic characteristic compensating unit 132.

Note that in the above description, the transfer function is expressed by a second-order lag system, but the present invention is not limited thereto.

### <<Control Processing>>

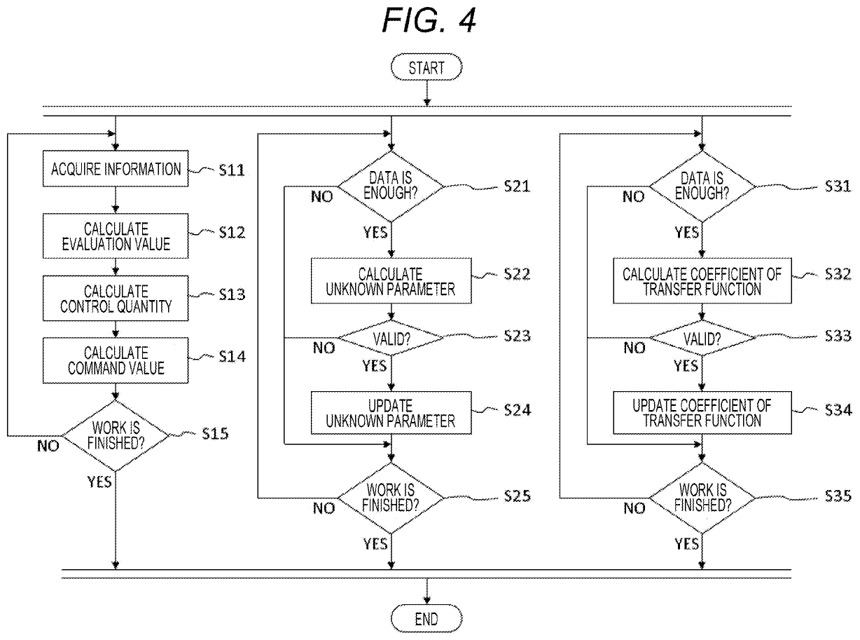

FIG. 4 is a flowchart of control processing according to the present embodiment. The control processing includes processing of steps S11 to S15 for controlling the controlled object 200 executed in parallel, processing of steps S21 to S25 for updating the state equation (see Formula (1)), and processing of steps S31 to S35 for updating the dynamic characteristic compensating unit 132.

The control processing further includes processing of the data recording unit 150 performed in parallel with these processing, but is not illustrated in FIG. 4. The data recording unit 150 acquires and records the measured values of the sensor, which are the state quantity x and the response value w of the controlled object 200, from the state detecting device 320. In addition, the data recording unit 150 acquires and records the control quantity u output from the control quantity calculating unit 116 and the command value v output from the command converting unit 130. Note that before the control processing in FIG. 4 starts, the basic model, the tracking target, the evaluation function, and the dynamic characteristic of the drive unit 210 have been set or acquired.

In step S11, the control quantity calculating unit 116 acquires the state quantity x of the controlled object 200 from the state detecting device 320 and the state quantity X of the environment from the environment measuring device 310.

In step S12, the control quantity calculating unit 116 calculates a value (an evaluation value) of the evaluation function J (see Expression (2)) from the state quantity X of the environment.

In step S13, the control quantity calculating unit 116 calculates the control quantity u so that the controlled object 200 operates along the tracking target and maximizes or minimizes a value of the evaluation function J.

In step S14, the command converting unit 130 converts the control quantity u into the command value v and outputs the command value v to the drive unit 210.

In step S15, the control quantity calculating unit 116 ends the control processing if the controlled object 200 has finished the work (reached an end point of the tracking target) (YES in step S15), and returns to step S11 if the controlled object 200 has not finished the work (NO in step S15).

In step S21, the model updating unit 115 determines whether the data of the state quantity x, the control quantity u, the command value v, and the response value w is enough to calculate the unknown parameter q of the state equation (see Expression (1)). The model updating unit 115 proceeds to step S22 if it is calculable (YES in step S21), and proceeds to step S25 if it is not calculable (NO in step S21).

In step S22, the model updating unit 115 calculates the unknown parameter q.

In step S23, if the unknown parameter q calculated in step S22 is valid (YES in step S23), the model updating unit 115 proceeds to step S24, and if not valid (NO in step S23), it proceeds to step S25.

In step S24, the model updating unit 115 calculates the unknown parameter q of the state equation. In step S13 after update, the control quantity calculating unit 116 refers to the updated unknown parameter q to calculate the control quantity u so that the controlled object 200 operates along the tracking target and maximizes or minimizes the value of the evaluation function J.

In step S25, the model updating unit 115 ends the control processing if the controlled object 200 has finished the work (reached the end point of the tracking target) (YES in step S25), and returns to step S21 if the controlled object 200 has not finished the work (NO in step S25).

In step S31, the conversion updating unit 140 determines whether the data of the state quantity x, the control quantity u, the command value v, and the response value w is enough to calculate the coefficient of the transfer function indicating the dynamic characteristic compensating unit 132. The conversion updating unit 140 proceeds to step S32 if it is calculable (YES in step S31), and proceeds to step S35 if it is not calculable (NO in step S31).

In step S32, the conversion updating unit 140 calculates the coefficients of the transfer function (see Expression (5)) indicating the dynamic characteristic compensating unit 132.

In step S33, if the coefficients of Formula (5) calculated in step S32 are valid (YES in step S33), the conversion updating unit 140 proceeds to step S34, and if not valid (NO in step S33), it proceeds to step S35.

In step S34, the conversion updating unit 140 updates the coefficient of the transfer function indicating the dynamic characteristic compensating unit 132. In step S14 after update, the command converting unit 130 (dynamic characteristic compensating unit 132) converts the control quantity u into the command value v with reference to the updated coefficient, and outputs the command value v to the drive unit 210.

In step S35, the conversion updating unit 140 ends the control processing if the controlled object 200 has finished the work (reached the end point of the tracking target) (YES in step S35), and returns to step S31 if the controlled object 200 has not finished the work (NO in step S35).

In the above steps S21 to S25, when the model updating unit 115 constructs the nonlinear Kalman filter and performs sequential state estimation, step S21 is always YES for calculation of the unknown parameter q.

Further, in step S23, if the unknown parameter q calculated in step S22 is calculated as the value deviating from the nominal value and the range of variation and is not valid (NO in step S23), the model updating unit 115 may prompt the operator to perform maintenance on the controlled object 200. Alternatively, the model updating unit 115 may instruct the control quantity calculating unit 116 to stop the controlled object 200.

### <<Characteristics of Control Processing>>

The model updating unit 115 estimates the unknown parameter q using the state quantity of the controlled object 200 and updates the state equation (see Expression (1)). Since the updated basic model is immediately (in the next calculation cycle) used for control quantity calculation by the control quantity calculating unit 116, the controlled object 200 can be controlled to operate along the tracking target and to further maximize or minimize the evaluation function J.

Further, conversion updating unit 140 updates the dynamic characteristic compensating unit 132 such that response value w of drive unit 210 matches the ideal response value w2 (see reference numeral 413 in FIG. 3). Since the updated dynamic characteristic compensating unit 132 is immediately (in the next calculation cycle) used for the command value calculation by the command converting unit 130, the controlled object 200 can be controlled to operate along the tracking target and to further maximize or minimize the evaluation function J.

Hereinafter, a first embodiment of the forklift and a second embodiment of the hydraulic excavator and a dump truck will be described as working machines.

### First Embodiment: Control of Forklift Truck at Factory and Distribution Site

An example when the control system 100 is applied to a factory or a distribution site will be described. FIG. 5 is a diagram illustrating a warehouse 550 provided in the factory or the distribution site according to the first embodiment. FIG. 6 is a functional block diagram of a forklift 510 according to the first embodiment.

In the warehouse 550, the forklift 510 (an autonomous machine) and a worker 520 carry baggage. Although one forklift 510 and one worker 520 are illustrated in FIG. 5, any of them may be plural or zero. The forklift 510 and a smart device 523 worn by the worker 520 have a communication function and can communicate with a control server 500. Note that the control server 500 is not necessarily installed in the warehouse 550.

### First Embodiment: Forklift

The forklift 510 includes a controller 511, programmable logic controllers (PLCs) 512 and 513, a drive motor 514, a steering motor 515, a battery 516, and a LiDAR 517. The PLCs 512 and 513 respectively control the drive motor 514 and the steering motor 515. The forklift 510 has a function of simultaneous localization and mapping (SLAM), and processes point cloud data collected by the LiDAR 517 to simultaneously create a map of the warehouse 550 and estimate an own position.

The forklift 510 is assumed to be configured to perform automatic driving (autonomous driving) by mounting the controller 511 on an existing electric forklift. The controller 511 executes various operations related to the automatic driving of the forklift 510. The controller 511 includes the control quantity calculating unit 116, the model updating unit 115, the command converting unit 130, and the conversion updating unit 140. In addition, the controller 511 includes a storage area (memory) and functions as the data recording unit 150.

### First Embodiment: Worker

The worker 520 wears the smart device 523. The smart device 523 measures the heart rate and the number of steps of the worker 520. The smart device 523 can measure a position of the worker 520 wearing the smart device 523 by performing wireless communication with a beacon 530 arranged in the warehouse 550.

### First Embodiment: Control Server

The control server 500 includes the operation setting unit 111, the basic model setting unit 112, the tracking target setting unit 113, and the evaluation function setting unit 114 in the control system 100 (see FIG. 1). The control server 500 calculates a fatigue state estimated from the heart rate, the number of steps, and the position of the worker 520 acquired from the smart device 523. In addition, the control server 500 receives a position of the forklift 510 from the LiDAR 517 and information on energy consumption (such as a change in state of charge (SOC)) from the battery 516.

### First Embodiment: Tracking Target

In the control system in the factory or the distribution site described above, it is assumed that the operator instructs the forklift 510 at a position 553 to collect an article at a position 554 and instructs the worker 520 at a position 555 to check an article at a position 556 using the operation setting unit 111 included in the control server 500. Then, the tracking target setting unit 113 sets a shortest route 558 from the position 553 to the position 554 for the forklift 510, and sets a shortest route 557 from the position 555 to the position 556 for the worker 520. Note that the instruction is not limited to the operator, and may be a system such as a distribution management system.

### First Embodiment: Basic Model

The basic model setting unit 112 sets the motion equation related to a vehicle system corresponding to the forklift 510 as the state equation (see Expression (1)). As a model of the vehicle system, a floor of the warehouse 550 is regarded as an X-Y plane, and the motion equation of calculating a set (x, y, θ) of a center of gravity coordinate (x, y) and an azimuth angle θ on the X-Y plane is used. At this time, a friction coefficient between the floor of the warehouse 550 and a tire is set as the unknown parameter q of the motion equation of the vehicle system.

### First Embodiment: Evaluation Function

As the KPI (evaluation function element) related to the operation policy of the forklift 510 in the warehouse 550, there are throughput (amount of articles that can be conveyed per unit time), energy consumption, and safety. The safety means that a distance between the forklift 510 and the worker, a wall, or a shelf is a certain value or more.

The throughput is expressed by an evaluation function element jᵢ in Equation (7) with a moving speed of the forklift 510 as (vₓ, v_{y}). It is considered that the throughput is higher as the speed is higher, and it is desirable that the evaluation function element jᵢ is minimized. Note that c in Equation (7) is a minute constant for preventing division by zero when the moving speed is 0.

$$[ Expression 7 ]$$

$${j}_{1} = \int \frac{1}{{v}_{x}^{2} + {v}_{y}^{2} + ε} dt \qquad ( 7 )$$

Regarding energy consumption, it is desirable that an absolute value of an amount of change ΔSOC of the battery 516 is small. It is desirable that an evaluation function element j₂ shown in Formula (8) is minimized.

### Expression 8

j₂=∫ΔSOC₂dt (8)

Regarding safety, it is desirable that the distance between the forklift 510 and the worker 520, the wall, or the shelf is large. For example, the safety of the worker 520 can be expressed by Formula (9) with coordinates of the forklift 510 as (x, y) and coordinates of the worker 520 as (x₀, y₀), and this is an example of designing so that an evaluation function element j₃ is small as a value of Formula (9) is small. It is desirable that the evaluation function element j₃ is minimized. The evaluation function element jᵢ may be calculated from a state including the moving speed and direction in addition to the position of the worker 520 who is not the controlled object 200. Note that ε is a minute constant similarly to Expression (7).

$$[ Expression 9 ]$$

$${j}_{3} = \int \frac{1}{{( x - {x}_{o} )}^{2} + {( y - {y}_{o} )}^{2} + ε} dt \qquad ( 9 )$$

The control system calculates by the controller 511 the control quantity so as to minimize the evaluation function J (see Expression (10)) obtained by linearly combining the evaluation function elements of Expressions (7) to (9) with a weight coefficient αᵢ. For example, when the operator instructs to prioritize the throughput, the evaluation function setting unit 114 sets a weighting coefficient α₁ related to the throughput to be larger than coefficients α₂ and α₃. Note that the safety can be set as a constraint condition without being provided as the evaluation function.

$$[ Expression 10 ]$$

$$J = {\sum }_{i = 1}^{3} {α}_{i} \cdot {j}_{i} ( X ) \qquad ( 10 )$$

### First Embodiment: Control of Forklift

The controller 511 calculates the vehicle speed and the steering angular velocity by performing optimum control (for example, model predictive control) using the state equation. In general, since the PLC that controls the motor can be driven by the speed command, conversion (see the steady characteristic converting unit 131) of a physical value is unnecessary in the present embodiment. However, when the calculated vehicle speed and steering angular velocity are realized by the actual forklift 510, the response is delayed.

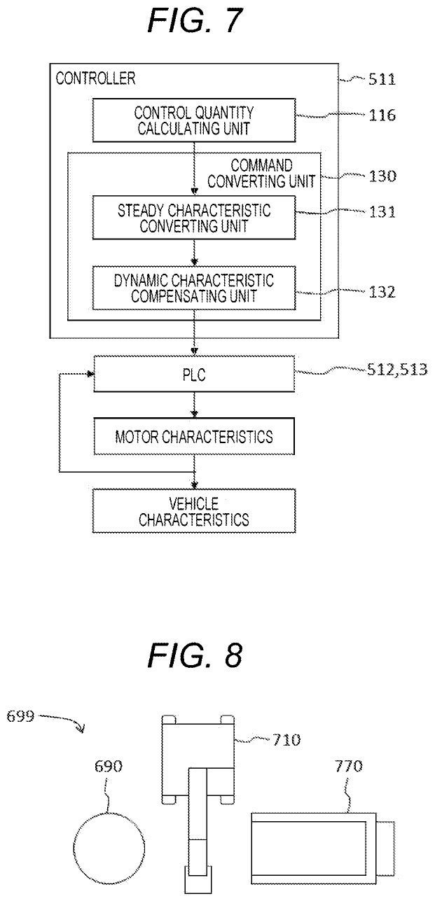

FIG. 7 is a diagram for explaining a dynamic characteristic of the forklift 510 according to the first embodiment. Since control quantities (velocity, angular velocity) output by the controller 511 (see FIG. 6) passes through the PLCs 512, 513, and motor characteristics (see the drive motor 514 and the steering motor 515), and vehicle characteristics, the response of the forklift 510 is delayed. Therefore, before the vehicle speed and the steering angle velocity calculated in the controller 511 are transmitted to the PLCs 512 and 513, it is necessary to calculate the command value to eliminate a response delay (see the dynamic characteristic compensating unit 132).

When the forklift truck 510 is operated, both the motor characteristics and the vehicle characteristics can be identified. The pre-filter feedforward control using this characteristic corresponds to an operation of the dynamic characteristic compensating unit 132. Calculation of the coefficient of the transfer function indicating the dynamic characteristic compensating unit 132 corresponds to design of the feedforward control, and the conversion updating unit 140 calculates the coefficient from the coordinate and the azimuth angle acquired by the LiDAR 517, the velocity and the angular velocity which are differential values thereof, the response of the drive motor 514, and the response of the steering motor 515.

Similarly, the unknown parameter q (friction coefficient) can be identified from a difference between changes in velocity and angular velocity predicted from the state equation (motion equation) set by the basic model setting unit 112 and changes in velocity and angular velocity actually acquired by the LiDAR 517.

### Features of First Embodiment

In the first embodiment, the parameter used for the control is automatically optimized while travel data of the forklift 510 is collected. In addition, the weight coefficient αᵢ included in the evaluation function J (see Expression (10)) can be appropriately changed for each work. Even when the evaluation function J changes, it is possible to appropriately calculate the control quantity u without updating the state equation (see Expression (1)), the unknown parameter q, and the transfer function (see Expression (5)) of the dynamic characteristic compensating unit 132.

### First Embodiment: Modification

In the first embodiment described above, the unknown parameter q is the friction coefficient between the floor of the warehouse and the tire. Other parameters may be (included in) the unknown parameter q. For example, a weight of the article carried by the forklift 510 may be included. Since the control quantity calculating unit 116 calculates the control quantity u according to the presence or absence and the weight of the article, the control system 100 can further optimally control the forklift 510 without manual operation.

### Second Embodiment: Control of Hydraulic Excavator and Dump Truck at Construction Site

An example when the control system 100 is applied to a construction site will be described. FIG. 8 is an overhead view of a construction site 699 according to the second embodiment. In the construction site 699, there are the hydraulic excavator 710 and a dump truck 770.

In the present embodiment, the hydraulic excavator 710 and the dump truck 770 are controlled objects 200. The hydraulic excavator 710 performs work of loading excavated earth and sand 690 onto the dump truck 770, and the dump truck 770 performs work of moving to a predetermined stopping position (loading position).

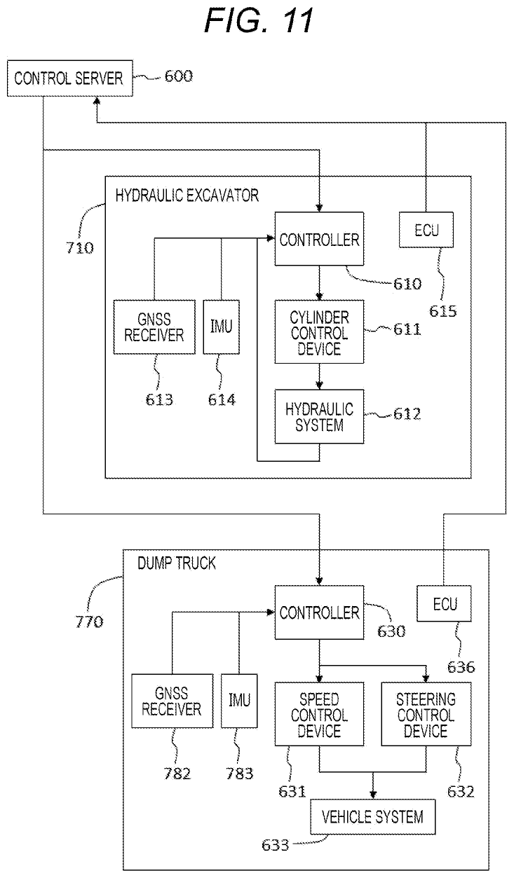

The hydraulic excavator 710 and the dump truck 770 have a wireless communication function, and perform data communication with a control server 600 (see FIG. 11 to be described later). The control server 600 may be installed in the construction site 699 or may be installed in a place different from the construction site 699.

### Second Embodiment: Hydraulic Excavator

FIG. 9 is a configuration diagram of the hydraulic excavator 710 according to the second embodiment. The hydraulic excavator 710 is a working machine corresponding to information-oriented construction, and incorporates various sensors and a cylinder control device for controlling each of hydraulic cylinders as illustrated in FIG. 9. The hydraulic excavator 710 includes an articulated front device 720 (front working machine), an upper swing body 740 constituting a vehicle body, and a lower traveling body 750. The upper swing body 740 is provided to be swingable with respect to the lower traveling body 750. The front device 720 is an articulated device configured by connecting a boom 711, an arm 712, and a bucket 713, which rotate in a vertical direction.

The boom 711, the arm 712, the bucket 713, the upper swing body 740, and the lower traveling body 750 are respectively driven by a boom cylinder 711A, an arm cylinder 712A, a bucket cylinder 713A, a swing motor 740A, and left and right traveling motors 750A (only one of the traveling motors is illustrated in FIG. 9), which are hydraulic actuators. Operation control of the boom cylinder 711A, the arm cylinder 712A, the bucket cylinder 713A, the swing motor 740A, and the left and right travel motors 750A is performed by controlling a direction and a flow rate of hydraulic oil supplied from a hydraulic pump 741 driven by a prime mover such as an engine or an electric motor to the above-described hydraulic actuators by a control valve 742. The boom cylinder 711A, the arm cylinder 712A, and the bucket cylinder 713A include a mechanism for controlling the control valve 742 so that each cylinder length has a desired value.

The engine mounted on the excavator 710 is a diesel engine, and it is known that a rapid change in engine output leads to an increase in harmful components (microparticles and nitrogen oxides) in exhaust gas. Further, an engine control unit (ECU) that controls the engine calculates a variable value related to a fuel injection amount, and can calculate energy consumption with reference to the variable value.

In the upper swing body 740, a vehicle body IMU 721 that is an inertial measurement unit (IMU) is disposed as a posture sensor. Note that the inertial measurement unit is a sensor that measures each of the angular velocity and an acceleration, but in the present embodiment, it is assumed that a function of calculating an inclination (angle) using the measured angular velocity and acceleration is also implemented on the sensor. In addition, a boom IMU 722, an arm IMU 723, and a bucket IMU 724, which are inertial measurement units, are installed at appropriate positions on the boom 711, the arm 712, and the bucket 713, which are constituent elements of the front device 720, in order to measure respective postures. Note that the bucket IMU 724 may be installed not on the bucket 713 but on a link member 714 that rotates in conjunction with the bucket. Further, an IMU 614 illustrated in FIG. 11 to be described later corresponds to the vehicle body IMU 721, the boom IMU 722, the arm IMU 723, and the bucket IMU 724.

Two positioning antennas 743 and 744 (global navigation satellite system (GNSS) antennas) are attached to the upper swing body 740. A GNSS receiver (see a GNSS receiver 613 in FIG. 11) not illustrated in FIG. 9 performs various positioning calculations such as calculation of antenna coordinates and calculation of the azimuth angle with reference to a satellite signal received by the positioning antennas 743 and 744.

The boom cylinder 711A is provided with a cylinder pressure sensor 715 that detects a cylinder pressure. The hydraulic excavator 710 of the present embodiment has a payload function of calculating a weight of the earth and sand loaded on the bucket 713 from a pressure of the boom cylinder 711A and posture information of the front device 720 (front working machine) acquired by each IMU.

A controller 610 (see FIG. 11) is mounted on the hydraulic excavator 710, to control various operations. The above-described mechanism for controlling the control valve 742 so that the cylinder length is the desired value may be a function of the controller 610 or a function of another controller.

### Second Embodiment: Dump Truck

FIG. 10 is a configuration diagram of the dump truck 770 which is an example of a conveyance vehicle according to the second embodiment. The dump truck 770 includes an operator cab 772 in front of a vehicle body frame 771 and a cargo bed 773 on the vehicle body frame 771. Further, the vehicle body frame 771 is supported by front wheels 774 and rear wheels 775 (hereinafter, also referred to as wheels), and moves forward and backward by rotation of the wheels. Note that in FIG. 10, regarding the rear wheels 775, a vehicle having a total of four wheels including two right and two left wheels is assumed, but is not limited to such a vehicle. For example, it may be a dump truck having one rear wheel 775 on each side and having a total of four wheels including the front wheels 774.

A power train such as an engine or a transmission (not illustrated) is provided behind the operator cab 772 or in the vehicle body frame 771, and movement of the wheels can be controlled by controlling the power train. The rotation of the wheels is controlled in accordance with operation of a brake pedal and an accelerator pedal in the operator cab 772. For example, when the brake operation is performed, it is possible to stop forward and backward movement of the dump truck 770 by pressing a brake pad attached to the wheel against the wheel. Control of the power train and the brake is executed via a controller 630 (see FIG. 11 to be described later).

The vehicle body frame 771 is provided with a cylinder 776, and the earth and sand and the like mounted on the cargo bed 773 can be discharged by sliding the cargo bed 773.

A positioning antenna 781, a GNSS receiver 782, and an IMU 783 are attached to the operator cab 772. In calculating the azimuth angle of the dump truck 770, it is desirable to attach two positioning antennas 781 similarly to the hydraulic excavator 710 so that the GNSS receiver 782 can calculate the position and the azimuth angle of the dump truck 770. However, even when only one positioning antenna 781 is provided, the GNSS receiver 782 may calculate only the position, and the controller 630 may calculate the azimuth angle using a traveling trajectory of the dump truck 770 and the angular velocity of the IMU 783. The GNSS receiver 782 can also acquire the moving speed by Doppler shift of the satellite signal received by the positioning antenna 781. Note that, although FIG. 10 illustrates a configuration in which the positioning antenna 781 is provided outside the operator cab 772, it may be a configuration in which a small positioning antenna is provided inside the cab 772.

Since the dump truck 770 is equipped with the diesel engine, the dump truck can measure an energy consumption amount and the like similarly to the hydraulic excavator 710.

FIG. 11 is a functional block diagram of the hydraulic excavator 710 and the dump truck 770 according to the second embodiment. In the second embodiment, the control server 600 receives the fuel consumption and engine power from ECUs 615 and 636 respectively mounted on the hydraulic excavator 710 and the dump truck 770. Furthermore, the control server 600 receives posture information of the hydraulic excavator 710 calculated by the controller 610 and posture information of the dump truck 770 calculated by the controller 630.

The control server 600 includes the operation setting unit 111, the basic model setting unit 112, the tracking target setting unit 113, and the evaluation function setting unit 114 in the control system. Hereinafter, description will be continued on the assumption that work in which the hydraulic excavator 710 loads the earth and sand 690 (see FIG. 8) onto the dump truck 770 is set in the operation setting unit 111.

### Second Embodiment: Basic Model

The basic model setting unit 112 sets the motion equation related to the vehicle system corresponding to the dump truck 770 as the state equation (see Expression (1)). On the other hand, for the hydraulic excavator 710, the basic model setting unit 112 models each of the upper swing body 740, the boom 711, the arm 712, and the bucket 713 as a link system simulated by a rigid link system.

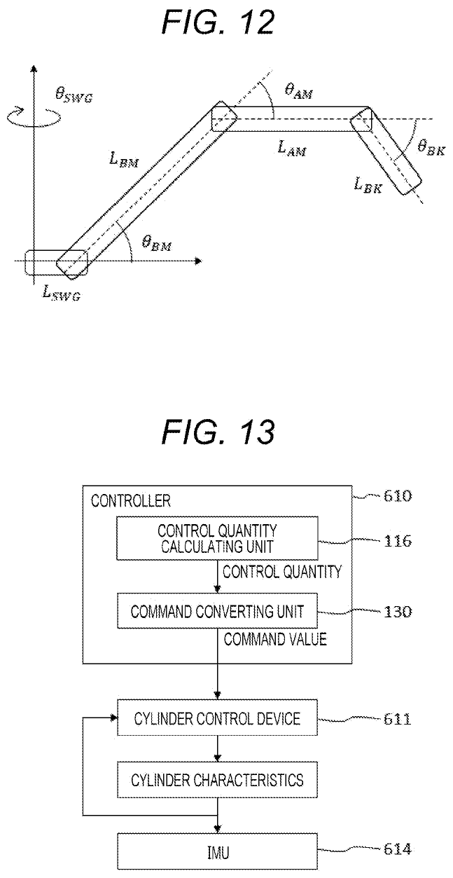

FIG. 12 is a diagram for explaining a basic model of the hydraulic excavator 710 according to the second embodiment. L_{SWG} indicates a length of the upper swing body 740 (length from a swing center to a rotation center of the boom 711), L_{BM} indicates a link length of the boom 711, L_{AM} indicates a link length of the arm 712, and L_{BK} indicates a link length of the bucket 713. Further, θ_{SWG} indicates a swing angle of the upper swing body 740, θ_{BM} indicates a link angle of the boom 711, θ_{AM} indicates a link angle of the arm 712, and θ_{BK} indicates a link angle of the bucket 713. Coordinate transformation f(L, θ) to a toe position z is given as expressed in Expressions (11) to (13) from these link lengths L and swing/link angles θ.

$$[ Expression 11 ]$$

$$z = f ( L , θ ) \qquad ( 11 )$$

$$[ Expression 12 ]$$

$$θ = [ \begin{matrix}{θ}_{BM} \\ {θ}_{AM} \\ {θ}_{BK} \\ {θ}_{SWG}\end{matrix} ] \qquad ( 12 )$$

$$[ Expression 13 ]$$

$$L = [ \begin{matrix}{L}_{BM} \\ {L}_{AM} \\ {L}_{BK} \\ {L}_{SWG}\end{matrix} ] \qquad ( 13 )$$

Since this coordinate transformation is a general coordinate transformation used in robotics, a detailed description thereof will be omitted. Similarly, conversion g(L, θ) from the link length L and the link angle θ to a cylinder length s of each link can be obtained as expressed in Expressions (14) and (15) from a geometric relationship.

$$[ Expression 14 ]$$

$$s = g ( L , θ ) \qquad ( 14 )$$

$$[ Expression 15 ]$$

$$S = [ \begin{matrix}{s}_{BM} \\ {s}_{AM} \\ {s}_{BK}\end{matrix} ] \qquad ( 15 )$$

Furthermore, not only static coordinate transformation but also a motion equation (state equation) regarding an angular velocity ω of a link determined by a cylinder velocity sᵥ as expressed in Expressions (16) to (18) can be derived in the link system. A viscous friction coefficient of each link in the motion equation is set as the unknown parameter q.

$$[ Expression 16 ]$$

$$ω = h ( θ , {s}_{v} , q ) \qquad ( 16 )$$

$$[ Expression 17 ]$$

$$ω = [ \begin{matrix}{ω}_{BM} \\ {ω}_{AM} \\ {ω}_{BK} \\ {ω}_{SWG}\end{matrix} ] \qquad ( 17 )$$

$$[ Expression 18 ]$$

$${s}_{v} = \dot{s} \qquad ( 18 )$$

Note that the basic model set by the basic model setting unit 112 is based on the premise that both the dump truck 770 and the hydraulic excavator 710 are in an unloaded state. Therefore, the weight of the earth and sand is also treated as the unknown parameter q. When the weight of the earth and sand increases, acceleration of the dump truck 770 decreases, front raising operation of the hydraulic excavator 710 is delayed, while front lowering operation is accelerated.

### Second Embodiment: Evaluation Function

As the KPI (evaluation function element) related to the operation policy of the hydraulic excavator 710 and the dump truck 770 in the construction site, there are throughput (loading work time), energy consumption, safety (that the hydraulic excavator 710 and the dump truck 770 do not come into contact with each other), exhaust gas properties (amount of harmful components), and the like. The control system according to the second embodiment calculates the control quantity u that minimizes the evaluation function J expressed in Expression (23) when the KPI is given by Expressions (19) to (22). Each KPI will be described below.

The KPI of the throughput is indicated by an evaluation function element j₁ of Expression (19). The faster the hydraulic excavator 710 operates and the faster the toe position z matches a loading position y_{d}, the smaller the value of the j₁ is.

$$[ Expression 19 ]$$

$${j}_{1} = \int {( z - {y}_{d} )}^{2} dt \qquad ( 19 )$$

The KPI of the energy consumption is indicated by an evaluation function element j₂ of Expression (20). Δfₑₓ is a fuel injection amount calculated by the ECU 615 (see FIG. 11) mounted on the hydraulic excavator 710, and Δfₜᵣ is a fuel injection amount calculated by the ECU 636 mounted on the dump truck 770. An integral value of the fuel injection amount is the evaluation function element j₂, and decreasing this value reduces energy consumption.

$$[ Expression 20 ]$$

$${j}_{2} = \int ( Δ {f}_{ex} + Δ {f}_{tr} ) dt \qquad ( 20 )$$

The KPI of the safety is indicated by the evaluation function element j₃ of Expression (21). By giving a penalty that takes a larger value as a distance between the toe position z of the hydraulic excavator 710 and a center position xₜᵣ of the dump truck 770 is reduced, it is possible to avoid collision between the hydraulic excavator 710 and the dump truck 770. Note that ε is a minute constant similarly to Expression (7).

$$[ Expression 21 ]$$

$${j}_{3} = \int \frac{1}{{( z - {x}_{tr} )}^{2} + ε} dt \qquad ( 21 )$$

The KPI of the exhaust gas properties is indicated by an evaluation function element j₄ of Expression (22). As a change ΔE_{pwr} in engine output is smaller, the amount of harmful components is reduced. An integral value of the change ΔE_{pwr} in engine output is the evaluation function element j₄, and reducing this value leads to reduction in the amount of harmful components.

### Expression 22

j₄=ΔE_{pwr}²dt (22)

The control system calculates by the controllers 610 and 630 the control quantity so as to minimize the evaluation function J (see Expression (23)) obtained by linearly combining the evaluation function elements of Expressions (19) to (22) with the weight coefficient αᵢ.

$$[ Expression 23 ]$$

$$J = {\sum }_{i = 1}^{4} {α}_{i} \cdot {j}_{i} ( X ) \qquad ( 23 )$$

Note that in consideration of the calculation cycle and communication cycle, calculation of the evaluation function J may be performed by the control server 600, but the calculation of the control quantity is desirably performed by the controllers 610 and 630 respectively of the hydraulic excavator 710 and the dump truck 770. Hereinafter, the calculation performed by the controllers 610 and 630 will be described.

### Second Embodiment: Control of Hydraulic Excavator

Returning to FIG. 11, the controller 610 of the hydraulic excavator 710 has a position and posture calculation function of calculating a position and posture of the hydraulic excavator 710 and a toe from information of the GNSS receiver 613 and the IMU 614 (see boom IMU 722, arm IMU 723, and bucket IMU 724 in FIG. 9), an earth and sand weight calculation function of calculating the weight of the earth and sand of the bucket from a pressure of the hydraulic cylinder, and a posture control function of controlling operation of the hydraulic excavator 710.

The position and posture calculation function calculates the position and posture of the hydraulic excavator 710 and the toe using Expression (11).

The earth and sand weight calculation function calculates the weight of the earth and sand in the bucket 713 using the posture information calculated by the position and posture calculation function and the cylinder pressure acquired by the pressure sensor. The weight of bucket 713 including the earth and sand greatly affects an inertia moment of front device 720. Therefore, the function of calculating the weight of the earth and sand corresponds to updating the basic model (unknown parameter q), and in the present embodiment, the earth and sand weight calculation function itself corresponds to the model updating unit 115.

The posture control function calculates the cylinder velocity sᵥ as the control quantity u so as to minimize the evaluation function J (see Expression (23)) using the motion equation (see Expressions (16) to (18)) considering the weight of the earth and sand. Therefore, the posture control function corresponds to the control quantity calculating unit 116.

In order to realize the calculated cylinder velocity sᵥ, it is necessary to convert the control quantity u into the command value v to be given to the cylinder control device mounted in an existing system (the hydraulic excavator).

FIG. 13 is a diagram for explaining conversion of the control quantity u into the command value v according to the second embodiment. The command converting unit 130 converts the control quantity u (cylinder velocity s_{V}) calculated by the control quantity calculating unit 116 into the command value v to a cylinder control device 611. When the cylinder control device 611 drives a hydraulic system 612 (see FIG. 11) to change the cylinder length, the link angle θ and the angular velocity ω change, and these values can be detected by the IMU 614 (see FIG. 11). When there is a difference between an actual cylinder velocity, which is a value detected by the IMU 614, and a desired cylinder velocity (the control quantity u) calculated from Expressions (14) to (18), the calculation (conversion, transfer function of Expression (5)) of the command value v is updated so as to eliminate the difference. The above calculation corresponds to the command converting unit 130 and the conversion updating unit 140.

In addition, it is also possible to identify the viscous friction coefficient (unknown parameter q) of each joint from each velocity detected by the IMU 614. This function corresponds to the model updating unit 115.

### Second Embodiment: Engine Model

In order to reduce the evaluation function element j₂ (see Expression (20)) and the evaluation function element j₃ (see Expression (21)), dynamic characteristics (behavior, dynamics) related to the engine and the ECU 615 are required. However, it is not easy to implement a complex model related to the engine in the controller 610.

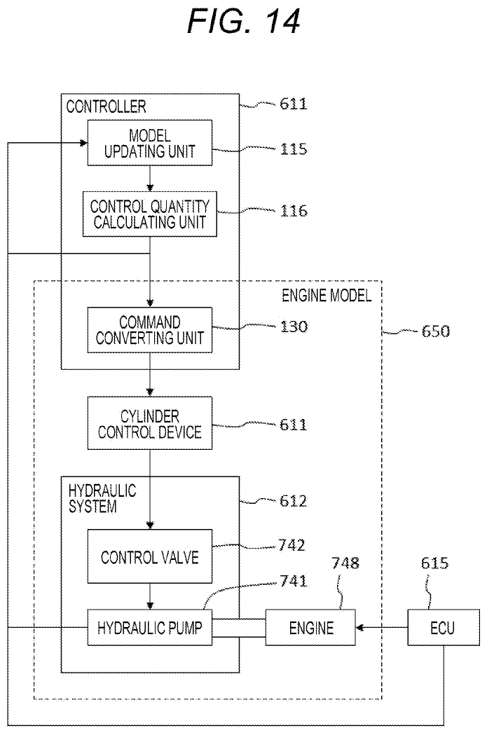

FIG. 14 is a diagram for explaining an engine model 650 according to the second embodiment. Power (Pump absorption power) required to drive the hydraulic system 612 can be measured from the pressure sensor of the hydraulic pump 741, and it is desirable to create a simple engine model by paying attention to the fact that the power is supplied from an engine 748. As illustrated in FIG. 14, regarding the engine power estimated from the pressure sensor attached to the hydraulic pump 741, the fuel injection amount received from the ECU 615, and the control quantity u, the engine model 650 in which the control quantity u is input and an engine output E_{pwr} and a fuel injection amount Δfₑₓ are outputs can be constructed. Such a construction method of the engine model 650 can also be employed in the controller 630 of the dump truck 770 described later.

### Second Embodiment: Control of Dump Truck

Returning to FIG. 11, the controller 630 of the dump truck 770 has the position and posture calculation function of calculating position and posture information of the dump truck 770 from the GNSS receiver 782 and information of the IMU 783, a loaded earth and sand weight calculation function of calculating a cumulative value of the weight of the earth and sand calculated by the controller 610 of the hydraulic excavator 710, and a vehicle control function of controlling operation of the dump truck 770.

The position and posture calculation function calculates a vehicle body posture of the dump truck 770 from a vehicle body position acquired by the GNSS receiver 782 and a detection result of the IMU 783.

The loaded earth and sand weight calculation function calculates the weight of the earth and sand loaded on the dump truck 770 by accumulating the weight of earth and sand loaded on the bucket 713 calculated by the controller 610. When the total weight of the dump truck 770 changes depending on the weight of the earth and sand loaded, an acceleration characteristic of the dump truck 770 changes. Therefore, the function of calculating the weight of the earth and sand loaded on the dump truck 770 also corresponds to an operation of updating the basic model (vehicle model), and in the present embodiment, the loaded earth and sand weight calculation function corresponds to the model updating unit 115.

The vehicle control function calculates the velocity and the angular velocity of the dump truck 770 as the control quantity u so as to minimize the evaluation function (see Expression (23)) using the motion equation considering the weight of the earth and sand. The vehicle control function corresponds to the control quantity calculating unit 116.

Similarly to an example of the forklift 510 of the first embodiment, the dump truck 770 can be appropriately controlled by performing conversion into the command value v output to a speed control device 631 and a steering control device 632.

### Features of Second Embodiment

As described above, the control system 100 is also effective in a case of simultaneously controlling a plurality of working machines such as the hydraulic excavator 710 and the dump truck 770. Note that even in a mode in which any one of the hydraulic excavator 710 and the dump truck 770 is boarded and operated by the worker, it is sufficient to stop control functions of the controllers 610 and 630 of a manned machine, and only the other working machine can be controlled to minimize the evaluation function J. That is, the control system 100 is also effective in an environment in which the autonomous machine (working machine controlled by the control system 100) and a non-autonomous machine (working machine operated by the worker) are mixed.

Although some embodiments of the present invention have been described above, these embodiments are merely examples and do not limit the technical scope of the present invention. The present invention can take various other embodiments, and various modifications such as omissions and substitutions can be made without departing from the gist of the present invention. These embodiments and modifications thereof are included in the scope and gist of the invention described in the present specification and the like, and are included in the invention described in claims and an equivalent scope thereof.

### REFERENCE SIGNS LIST

100 control system
111 operation setting unit
112 basic model setting unit
113 tracking target setting unit
114 evaluation function setting unit
115 model updating unit
116 control quantity calculating unit
130 command converting unit
131 steady characteristic converting unit
132 dynamic characteristic compensating unit
140 conversion updating unit
200 controlled object
210 drive unit
510 forklift (controlled object)
520 worker (moving body other than controlled object)
550 warehouse (work area)

1. A control system comprising:
a control quantity calculating unit for calculating, on a basis of an operation target, an evaluation index of an operation, and an operation model of a controlled object that is a working machine, a control quantity for driving the controlled object; and
a model updating unit for updating the operation model on a basis of a state quantity of the controlled object.

2. The control system according to claim 1, further comprising:
a command converting unit for converting the control quantity into a command value for a drive unit of the controlled object; and
a conversion updating unit for updating a conversion characteristic from the control quantity to the command value on a basis of the command value and a response of the controlled object.

3. The control system according to claim 1, further comprising a tracking target setting unit for receiving a start state and an end state of an operation of the controlled object, calculating a shortest operation path from the start state to the end state, and setting the operation path as the operation target.

4. The control system according to claim 1, wherein the evaluation index includes an evaluation index related to at least one of a state of the controlled object in a work area where the controlled object exists, a state of an object different from the controlled object existing in the work area, and an environmental state of the work area.

5. The control system according to claim 2, wherein
the command converting unit is configured to include a steady characteristic converting unit and a dynamic characteristic compensating unit, and
the dynamic characteristic compensating unit is a feedforward controller for compensating for a response delay of the drive unit.

6. The control system according to claim 5, wherein
the conversion updating unit calculates and updates a coefficient of a transfer function indicating a conversion characteristic of the dynamic characteristic compensating unit, and
when the transfer function including a calculated coefficient has an unstable pole, the coefficient is not reflected in the transfer function indicating the conversion characteristic of the dynamic characteristic compensating unit.

7. The control system according to claim 1, wherein
the operation model is indicated by a physical model,
the model updating unit calculates and updates a parameter included in the physical model on a basis of the state quantity of the controlled object, and
when the parameter calculated is not within a predetermined range, the parameter is not reflected in the physical model.

8. The control system according to claim 1, wherein
the operation model is indicated by a physical model,
the model updating unit calculates and updates a parameter included in the physical model on a basis of the state quantity of the controlled object,
a notification is transmitted to the control quantity calculating unit when the parameter calculated is not within a predetermined range, and
the control quantity calculating unit controls the controlled object to stop upon receiving the notification.

9. The control system according to claim 1, wherein the evaluation index includes at least one of productivity of the controlled object, energy consumption, a distance to an object other than the controlled object, and exhaust gas properties.

10. A control method, wherein a control system for controlling a controlled object that is a working machine performs
a step of calculating a control quantity for driving the controlled object on a basis of an operation target, an evaluation index of an operation, and an operation model of the controlled object, and
a step of updating the operation model on a basis of a state quantity of the controlled object.
